(19) United States
(12) Patent Application Publication
(10) Pub. No.: US 2026/0036745 A1
(43) Pub. Date: Feb. 5, 2026

(54) MULTIMODE COMBINER

(71) Applicant: Cisco Technology, Inc., San Jose, CA (US)

(72) Inventor: Jean-Luc J. TAMBASCO, Macungie, PA (US)

(21) Appl. No.: 18/792,412

(22) Filed: Aug. 1, 2024

(51) Int. Cl. G02B 6/122; G02B 6/12; H04J 14/04

(52) U.S. Cl. CPC G02B 6/1228; H04J 14/04; G02B 2006/12164

(57) ABSTRACT

A multimode combiner is disclosed. In one aspect, a multimode combiner includes a first input waveguide, a second input waveguide, and an output waveguide disposed between the first and second input waveguides. The first input waveguide, the second input waveguide, and the output waveguide are arranged such that an optical signal transmitted through the multimode combiner has substantially the same optical power at an output of the output waveguide as the optical signal does at an input of either of the first and second input waveguides. A multiplexer and an apparatus including multimode combiners are also disclosed.

### TECHNICAL FIELD

Embodiments presented in this disclosure generally relate to photonic components. More specifically, embodiments disclosed herein relate to optical combiners.

### BACKGROUND

Adiabatic combiners are photonic components used to combine multiple optical inputs into a single output. Adiabatic combiners can be implemented in a number of applications, including optical transceivers. In some instances, it may be desirable to launch optical signals, one at a time, into optical channels of an optical transceiver so that a photodetector can sample the performance of the channels. The photodetector can have fewer inputs than there are optical channels, and thus, the optical transceiver can include adiabatic combiners to combine the optical channels. Conventional adiabatic combiners are subject to insertion loss. That is, for conventional adiabatic combiners, optical signals transmitted therethrough loose some portion of their optical power. Consequently, the optical power of the optical signals launched into such optical transceivers must be set at a higher power level to account for the insertion loss, which takes away optical power from other optical circuits, among other drawbacks.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 is a schematic view of an apparatus according to one example embodiment of the present disclosure.

FIGS. 2A, 2B, and 2C depict various views of a 2-mode combiner according to one example embodiment of the present disclosure.

FIGS. 2D and 2E depict the 2-mode combiner of FIG. 2A with an optical signal transmitted therethrough.

FIGS. 3A, 3B, and 3C depict various views of a 4-mode combiner according to one example embodiment of the present disclosure.

FIGS. 3D and 3E depict the 4-mode combiner of FIG. 3A with an optical signal transmitted therethrough.

FIGS. 4A and 4B depict a multiplexer according to one example embodiment of the present disclosure.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure is directed to a multimode combiner. The multimode combiner includes a first input waveguide, a second input waveguide, and an output waveguide disposed between the first and second input waveguides. The first input waveguide, the second input waveguide, and the output waveguide are arranged such that an optical signal transmitted through the multimode combiner has substantially the same optical power at an output of the output waveguide as the optical signal does at an input of either of the first and second input waveguides.

Another embodiment presented in this disclosure is directed to a multiplexer. The multiplexer includes a first combiner having two single mode input waveguides and one multimode output waveguide. The multiplexer also includes a second combiner having two single mode input waveguides and one multimode output waveguide. Further, the multiplexer includes a third combiner having two multimode input waveguides and one multimode output waveguide, the two multimode input waveguides of the third combiner are respectively coupled with the multimode output waveguides of the first and second combiners. The multimode output waveguides of the first, second, and third combiners each support, at their respective outputs, at least one higher order optical mode in addition to a fundamental mode of an optical signal transmitted therethrough, with the multimode output waveguide of the third combiner supporting at least twice a number of optical modes that the multimode output waveguides of the first and second combiners support.

In some embodiments, the first combiner, the second combiner, and the third combiner are arranged such that an optical signal transmitted through the multiplexer has substantially the same optical power at an output of the multimode output waveguide of the third combiner as the optical signal does at an input of any one of the single mode input waveguides of the first combiner or the second combiner.

A further embodiment presented in this disclosure is directed to an apparatus. The apparatus includes a photodetector having an input. The apparatus also includes a multiplexer. The multiplexer has a first stage having a first combiner and a second combiner each having two single mode input waveguides and one multimode output waveguide. The multiplexer also has a second stage having a third combiner having two multimode input waveguides and one multimode output waveguide. The two multimode input waveguides of the third combiner are respectively coupled with the multimode output waveguides of the first and second combiners. The multimode output waveguide of the third combiner is coupled with the input of the photodetector. Further, the first combiner, the second combiner, and the third combiner are arranged such that an optical signal launched into an input of any one of the single mode input waveguides of the first combiner or the second combiner and transmitted through the third combiner has substantially the same optical power at the input of the photodetector as the optical signal does at the input of any one of the single mode input waveguides of the first combiner or the second combiner.

### EXAMPLE EMBODIMENTS

Various embodiments disclosed herein are directed to optical combiners, as well as to multiplexers and apparatuses that include such combiners. Some adiabatic combiners transmit the fundamental optical mode of an optical signal, while higher order optical modes become “cutoff” as the combiner directs the optical signal from one of a plurality of inputs to a single output. Consequently, some of the optical power of the optical signal is lost during transmission. Stated differently, the optical signal is subject to insertion loss. If an optical signal is transmitted through multiple combiners of a multiplexer, the insertion loss can compound.

The combiners of the present disclosure are arranged in such a way so as to passively transmit optical signals with none or negligible insertion loss. In this way, an optical signal transmitted through a combiner of the present disclosure can have the same or substantially the same optical power at an output of the combiner as it has at an input of the combiner. In this regard, the combiners of the present disclosure are arranged in such a way that one or more higher order optical modes are guided to an output of the combiner in addition to the fundamental optical mode. Stated another way, the combiners of the present disclosure are arranged so that the optical supermodes of the optical signal guided into an input of a combiner are guided throughout the combiner to an output of the combiner, and thus, no or negligible optical power is lost.

The combiners, multiplexers, and apparatuses of the present disclosure can provide one or more advantages, benefits, and/or technical effects. For instance, in one example aspect, combiners of the present disclosure can be disposed in a cascade arrangement to form a multiplexer (e.g., a 4 to 1 multiplexer) of an apparatus, such as an optical transceiver. The apparatus can include a photodetector arranged to receive optical signals transmitted over optical channels. In some instances, it may be desirable to launch optical signals, one at a time, into the optical channels so that the photodetector can sample the performance of the channels. The photodetector can have fewer inputs than there are optical channels, and thus, the combiners can be used to combine the optical channels. Given the architectural arrangement of the combiners of the present disclosure, an optical signal transmitted along one of the channels through some combination of the combiners can have substantially the same optical power at an input of the multiplexer as the optical signal does at an output of the multiplexer, or rather, the input of the photodetector. Stated another way, the combiners are arranged so that higher order optical modes do not become “cutoff” as the combiners direct the optical signal along the channel to the photodetector. Consequently, none or only a negligible portion of the optical power of an optical signal transmitted through the multiplexer is lost. Accordingly, advantageously, the optical power of optical signals launched into the apparatus can be set at lower power levels due to the lack of insertion loss associated with the combiners, which may allow for more light to be sent to other optical circuits, such as more critical optical circuits.

Further, the combiners of the present disclosure can be broadband, low insertion loss, relatively compact (e.g., smaller than thermo-optic switching devices), and fabrication tolerant, allowing higher density photonics. Also, advantageously, the combiners can be arranged as passive devices that do not require active control.

As used herein, an optical signal has “substantially the same” optical power at a downstream point as the optical signal does at an upstream point of an optical channel when the optical power of the optical signal at the downstream point is within 5% of the optical power of the optical signal at the upstream point. As used herein, an optical signal has “nearly the same” optical power at a downstream point as the optical signal does at an upstream point when the transmission loss of the optical signal between the stated points is less than or equal to 0.05 dB.

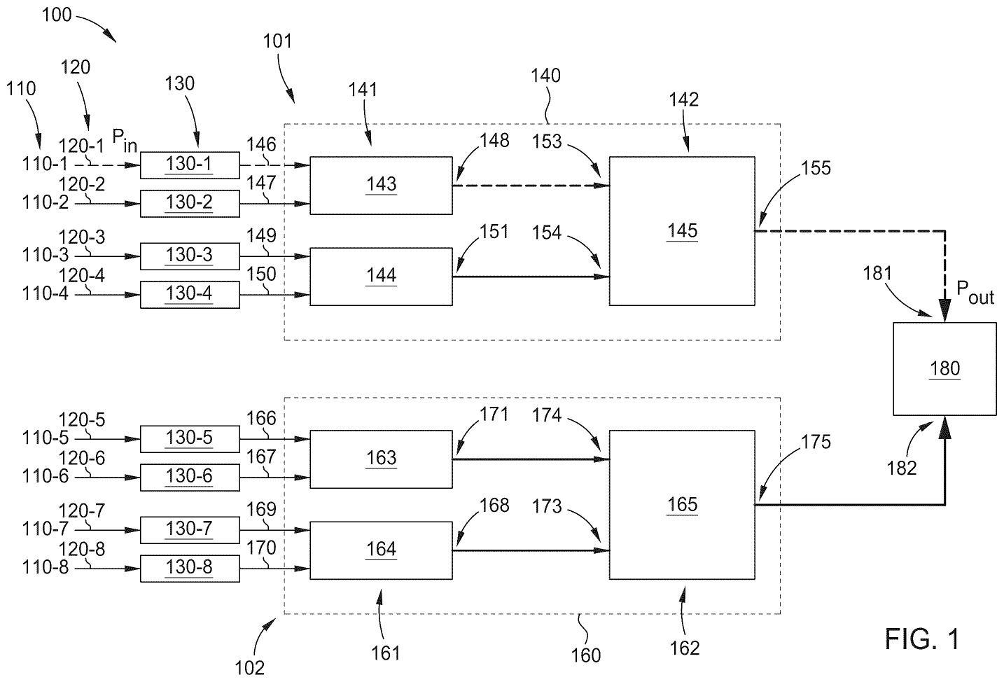

FIG. 1 is a schematic view of an apparatus 100 according to one example embodiment of the present disclosure. The apparatus 100 can be implemented in, among other possible applications, an optical transceiver or optical module for networking systems. As depicted, the apparatus 100 includes a plurality of attenuators 130, first and second multiplexers 140, 160, and a photodetector 180. A first set of the attenuators 130 and the first multiplexer 140 are arranged along a first arm 101 of the apparatus 100 and a second set of the attenuators 130 and the second multiplexer 160 are arranged along a second arm 102 of the apparatus 100. Further, the apparatus 100 has a plurality of optical channels 110. For the depicted embodiment of FIG. 1, the apparatus 100 has eight (8) optical channels or lanes, with four (4) of the optical channels being associated with the first arm 101 and four (4) of the optical channels being associated with the second arm 102. While the apparatus 100 is shown having two arms in FIG. 1, the apparatus 100 can have a single arm or more than two arms in other embodiments.

The apparatus 100 is arranged so that an optical signal launched into any one of the optical channels 110 can pass through one of the attenuators 130 and one of the multiplexers 140, 160, and then can be received and detected by the photodetector 180. As illustrated in FIG. 1, the optical channels 110 have respective channel inputs 120. That is, each one of the optical channels 110 has a channel input into which an optical signal can be launched. The attenuators 130, which can be variable optical attenuators (VOA), can each be arranged to switch between states (e.g., “on” and “off” states) to selectively allow an optical signal to be transmitted along its associated optical channel. For instance, in the “on” state, an attenuator can allow an optical signal to travel along its associated optical channel. That is, when one of the attenuators 130 is switched “on”, an optical signal can travel through the attenuator switched “on”, through the first or second multiplexer 140, 160, and to the photodetector 180. In contrast, in the “off” state, an attenuator can prevent an optical signal from traveling along its associated optical channel.

The first multiplexer 140 includes a first stage 141 and a second stage 142. The first stage 141 has first and second 2-mode combiners 143, 144 while the second stage 142 has a 4-mode combiner 145. The first and second 2-mode combiners 143, 144 of the first stage 141 are arranged in a cascade arrangement with the 4-mode combiner 145 of the second stage 142. As depicted in FIG. 1, the first 2-mode combiner 143 has two single mode inputs 146, 147 and one multimode output 148. Similarly, the second 2-mode combiner 144 has two single mode inputs 149, 150 and one multimode output 151. Thus, the first and second 2-mode combiners 143, 144 each have two single mode inputs and one multimode output. The 4-mode combiner 145 has two 2-mode inputs 153, 154 and one 4-mode output 155. The two 2-mode inputs 153, 154 of the 4-mode combiner 145 are coupled with the multimode outputs 148, 151 of the first and second 2-mode combiners 143, 144. Moreover, the 4-mode output 155 of the 4-mode combiner 145 is coupled with a first input 181 of the photodetector 180. Thus, the first multiplexer 140 is arranged as a 4×1 multiplexer (or four inputs to one output).

The second multiplexer 160 is configured in a similar manner as the first multiplexer 140. The second multiplexer 160 includes a first stage 161 and a second stage 162. The first stage 161 has first and second 2-mode combiners 163, 164 while the second stage 162 has a 4-mode combiner 165. The first and second 2-mode combiners 163, 164 of the first stage 161 are arranged in a cascade arrangement with the 4-mode combiner 165 of the second stage 162. As shown in FIG. 1, the first 2-mode combiner 163 has two single mode inputs 166, 167 and one multimode output 168. Similarly, the second 2-mode combiner 164 has two single mode inputs 169, 170 and one multimode output 171. Accordingly, the first and second 2-mode combiners 163, 164 each have two single mode inputs and one multimode output. The 4-mode combiner 165 has two 2-mode inputs 173, 174 and one 4-mode output 175. The two 2-mode inputs 173, 174 of the 4-mode combiner 165 are coupled with the multimode outputs 168, 171 of the first and second 2-mode combiners 163, 164. Moreover, the 4-mode output 175 of the 4-mode combiner 165 is coupled with a second input 182 of the photodetector 180. Thus, the second multiplexer 160 is arranged as a 4×1 multiplexer (or four inputs to one output).

In some implementations, only one of the attenuators 130 is switched “on” at a time. In this way, the photodetector 180 can sample the light or optical power of an optical signal traveling along one channel at a time. In FIG. 1, a first attenuator 130-1 of the attenuators 130 has been switched “on” and an optical signal is shown traveling along a first optical channel 110-1 of the optical channels 110. The optical signal launched into a first channel input 120-1 can travel along the first optical channel 110-1 through the first attenuator 130-1 and to the first 2-mode combiner 143 of the first multiplexer 140 via the single mode input 146, through the first 2-mode combiner 143, to the 4-mode combiner 145 of the first multiplexer 140 via the multimode output 148 and the multimode mode input 153, through the 4-mode combiner 145, and to the photodetector 180 via the multimode output 155 and the first input 181. The photodetector 180 can thus read the optical power of the optical signal launched into the first optical channel 110-1.

Then, although not shown, the first attenuator 130-1 can be switched “off” and another attenuator can be switched “on”, such as a second attenuator 130-2 of the attenuators 130. An optical signal launched into a second channel input 120-2 can travel along a second optical channel 110-2 of the optical channels 110. The optical signal can travel along the second optical channel 110-2 through the second attenuator 130-2 and to the first 2-mode combiner 143 of the first multiplexer 140 via the single mode input 147, through the first 2-mode combiner 143, to the 4-mode combiner 145 of the first multiplexer 140 via the multimode output 148 and the multimode mode input 153, through the 4-mode combiner 145, and to the photodetector 180 via the multimode output 155 and the first input 181. The photodetector 180 can thus read the optical power of the optical signal launched into the second optical channel 110-2.

Next, the second attenuator 130-2 can be switched “off” and another attenuator can be switched “on”, such as a third attenuator 130-3 of the attenuators 130. An optical signal launched into a third channel input 120-3 can travel along a third optical channel 110-3 of the optical channels 110. The optical signal can travel along the third optical channel 110-3 through the third attenuator 130-3 and to the second 2-mode combiner 144 of the first multiplexer 140 via the single mode input 149, through the second 2-mode combiner 144, to the 4-mode combiner 145 of the first multiplexer 140 via the multimode output 151 and the multimode mode input 154, through the 4-mode combiner 145, and to the photodetector 180 via the multimode output 155 and the first input 181. The photodetector 180 can thus read the optical power of the optical signal launched into the third optical channel 110-3.

Further, the third attenuator 130-3 can be switched “off” and another attenuator can be switched “on”, such as a fourth attenuator 130-4 of the attenuators 130. An optical signal launched into a fourth channel input 120-4 can travel along a fourth optical channel 110-4 of the optical channels 110. The optical signal can travel along the fourth optical channel 110-4 through the fourth attenuator 130-4 and to the second 2-mode combiner 144 of the first multiplexer 140 via the single mode input 150, through the second 2-mode combiner 144, to the 4-mode combiner 145 of the first multiplexer 140 via the multimode output 151 and the multimode mode input 154, through the 4-mode combiner 145, and to the photodetector 180 via the multimode output 155 and the first input 181. The photodetector 180 can thus read the optical power of the optical signal launched into the fourth optical channel 110-4.

This process can continue with the second arm 102, with fifth, sixth, seventh, and eighth attenuators 130-5, 130-6, 130-7, 130-8 being switched “on” one at a time so that optical signals launched into respective channel inputs 120-5, 120-6, 120-7, 120-8 can travel along their respective fifth, sixth, seventh, and eighth optical channels 110-5, 110-6, 110-7, 110-8 and ultimately be received and read, one at a time, by the photodetector 180.

In at least some example embodiments, the apparatus 100, or first and second multiplexers 140, 160 thereof, can be arranged so that an optical signal launched into any one of the optical channels 110 has substantially the same optical power at an input of the photodetector 180 as the optical signal does at an input of the apparatus 100, or rather, at the input of the channel into which the optical signal is launched. Accordingly, the apparatus 100 can advantageously enable sampling or testing of the channels with optical signals subject to none or negligible insertion loss. This efficiency can allow for an optical signal with less power to be sent to the photodetector 180 (as there is none or negligible signal loss as the optical signal travels through the apparatus 100), which is beneficial in that more light can be sent to other circuits, including more critical circuits in some instances. Moreover, as will be explained below, the first and second multiplexers 140, 160 can include passive combiners, or rather, combiners that can passively direct, without active elements, an optical signal from one of a plurality of inputs to a single output. This can, among other things, reduce or eliminate the need for electric power to control the apparatus 100 as well as additional considerations associated with controlling active elements.

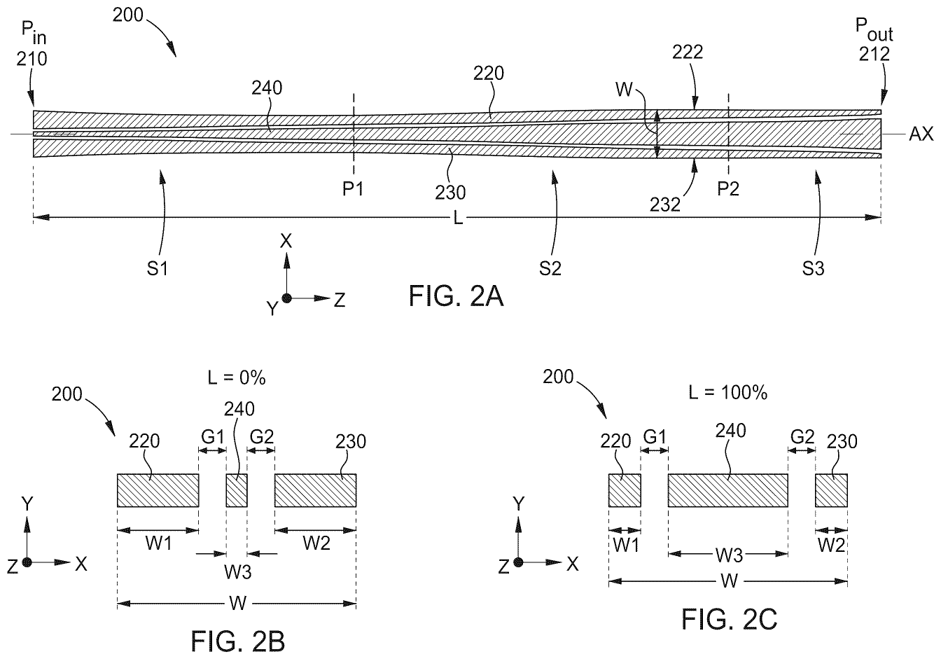

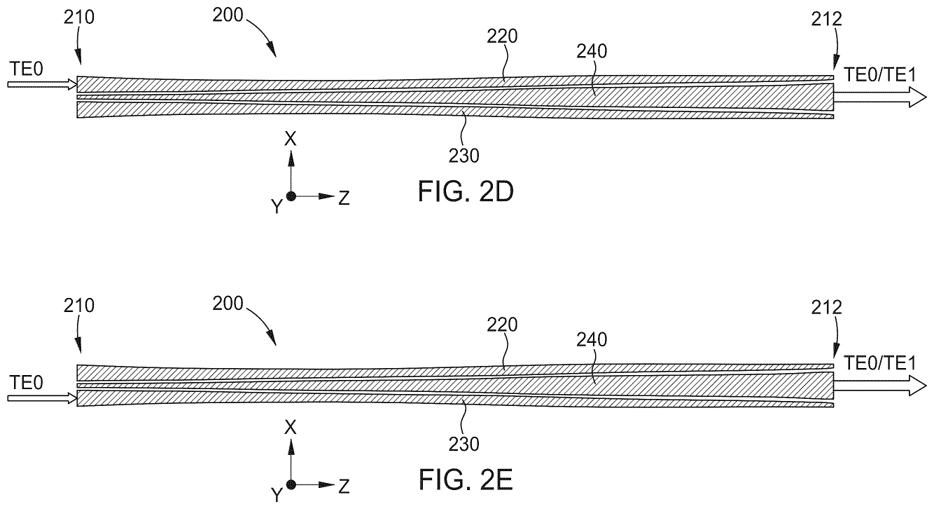

FIGS. 2A, 2B, and 2C depict various views of a 2-mode combiner 200 according to one example embodiment of the present disclosure. FIG. 2A shows a top view of the 2-mode combiner 200 while FIGS. 2B and 2C show cross-sectional views at an input 210 and an output 212 of the 2-mode combiner 200, respectively. The 2-mode combiner 200 can be implemented in the apparatus 100 of FIG. 1, for example. For instance, any one of the 2-mode combiners 143, 144, 163, 164 of the apparatus 100 of FIG. 1 can be configured in a same or similar manner as the 2-mode combiner 200. In addition, for reference, the 2-mode combiner 200 defines a first direction Z, a second direction X, and a third direction Y. The first direction Z can be a longitudinal direction, the second direction can be a lateral direction, and the third direction Y can be a vertical direction, for example. The first direction Z, the second direction X, and the third direction Y are mutually perpendicular to one another. The 2-mode combiner 200 has a length L, which extends between the input 210 and the output 212 of the 2-mode combiner 200, e.g., along the first direction Z. In at least some embodiments, the length L is equal to or greater than 20 μm.

The 2-mode combiner 200 includes a first input waveguide 220, a second input waveguide 230, and an output waveguide 240 disposed between the first and second input waveguides 220, 230. The waveguides 220, 230, 240 can be formed of silicon, for example. The output waveguide 240 is a multimode waveguide and the first and second input waveguides 220, 230 are single mode waveguides. The first input waveguide 220 can be associated with a first optical channel, the second input waveguide 230 can be associated with a second optical channel, and the output waveguide 240 can be associated with both the first and second optical channels. Generally, the 2-mode combiner 200 is arranged so that an optical signal traveling along the first optical channel can be directed from the first input waveguide 220 to the output waveguide 240, and similarly, so that an optical traveling along the second optical channel can be directed from the second input waveguide 230 to the output waveguide 240. In this way, the 2-mode combiner 200 is a 2×1 multimode combiner (two inputs to one output combiner). The 2-mode combiner 200 is generally configured as a Y-combiner. In at least some embodiments, the 2-mode combiner 200 is symmetric along a center axis AX extending along the first direction Z. In this regard, the first and second input waveguides 220, 230 mirror each other with respect to the central axis AX.

The first input waveguide 220 has a width W1, the second input waveguide W2 has a width W2, and the output waveguide 240 has a width W3. The first and second input waveguides 220, 230 and the output waveguide 240 vary in width along the length L of the 2-mode combiner 200, with the widths W1, W2 of the first and second input waveguides 220, 230 and the width W3 of the output waveguide 240 varying along the second direction X. In at least some embodiments, the width W3 of the output waveguide 240 inverse tapers along the length L from the input 210 to the output 212 of the 2-mode combiner 200. That is, the width W3 of the output waveguide 240 increases as the output waveguide 240 extends toward the output 212 along the first direction Z. Further, in at least some embodiments, the widths W1, W2 of the first and second input waveguides 220, 230 taper, each with a non-linear profile, along the length L of the 2-mode combiner 200 from the input 210 to the output 212. In yet other embodiments, the widths W1, W2 of the first and second input waveguides 220, 230 can taper in a linear manner along the length L of the 2-mode combiner 200 from the input 210 to the output 212.

In at least some further embodiments, the widths W1, W2 of the first and second input waveguides 220, 230 at the input 210 are each greater than the width W3 of the output waveguide 240 at the input 210. At the output 212 of the 2-mode combiner 200, the width W3 of the output waveguide 240 is greater than the width W1 of the first input waveguide 220 and the width W2 of the second input waveguide 230. In at least some embodiments, the width W3 of the output waveguide 240 at the output 212 of the 2-mode combiner 200 is greater than the width W1 of the first input waveguide 220 and greater than the width W2 of the second input waveguide 230 at the input 210 of the 2-mode combiner 200. This may be appreciated by comparing the widths W1, W2 of the first and second input waveguides 220, 230 in FIG. 2B with the width W3 of output waveguide 240 in FIG. 2C. In at least some embodiments, the output waveguide 240 constantly increases in width along the length L of the 2-mode combiner 200 from the input 210 to the output 212. That is, in some embodiments, the width W3 constantly increases along the length L from the input 210 to the output 212.

The first input waveguide 220 is spaced from the output waveguide 240 along the second direction X and the second input waveguide 230 is likewise spaced from the output waveguide 240 along the second direction X. Particularly, a first gap G1 is defined between the first input waveguide 220 and the output waveguide 240. Similarly, a second gap G2 is defined between the second input waveguide 230 and the output waveguide 240. In at least some embodiments, the first gap G1 and the second gap G2 remain fixed along the length L of the 2-mode combiner 200. Stated differently, the edge-to-edge gap between the first input waveguide 220 and the output waveguide 240 and the edge-to-edge gap between the second input waveguide 230 and the output waveguide 240 can both remain constant along the length L of the 2-mode combiner 200.

The 2-mode combiner 200 has a total width W, as measured from an outer edge 222 of the first input waveguide 220 to an outer edge 232 of the second input waveguide 230. In at least some embodiments, the total width W can vary along the length L of the 2-mode combiner 200. For the depicted embodiment of FIG. 2A, for example, the total width W decreases or remains constant along a first section S1 of the length L of the 2-mode combiner 200 from the input 210 until reaching a first inflection plane P1, increases or remains constant along a second section S2 of the length L adjacent the first section S1 until reaching a second inflection plane P2, and then decreases or remains constant along a third section S3 of the length L adjacent the second section S2 until reaching the output 212.

In at least some embodiments, the first input waveguide 220, the second input waveguide 230, and the output waveguide 240 are arranged such that an optical signal transmitted through the 2-mode combiner 200 has substantially the same optical power at an output of the output waveguide 240 as the optical signal does at an input of either of the first and second input waveguides 220, 230. In this regard, an optical signal traveling through the 2-mode combiner 200 has none or negligible insertion loss. That is, the optical power of an optical signal at the input 210, or Pin, is equal to or approximately equal to the optical power of the optical signal at the output 212, or rather, so that Pin≈Pout. Such a result can be achieved passively by the architecture of the waveguides of the 2-mode combiner 200. For instance, the waveguides 220, 230, 240 of the 2-mode combiner 200 can be arranged such that a higher order optical mode excited by transmission of an optical signal through the 2-mode combiner 200 does not radiate away from the waveguides or become “lost” prior to reaching the output 212 of the 2-mode combiner 200. Accordingly, the higher order optical mode reaches the output 212 of the 2-mode combiner 200 along with the fundamental optical mode of the optical signal. This prevents or greatly reduces the insertion loss of an optical signal transmitted through the 2-mode combiner 200.

In at least some embodiments, for instance, the 2-mode combiner 200 is arranged so that the first input waveguide 220 is wide enough at its input to support one optical mode, the second input waveguide 230 is wide enough at its input to support one optical mode, and the output waveguide 240 is wide enough at its output to support two optical modes. Stated another way, in some embodiments, the total width W of the 2-mode combiner 200 is wide enough along its length L so that a higher order optical mode (e.g., TE1) excited by the optical signal traveling through the 2-mode combiner 200 is supported by the 2-mode combiner 200, in addition to the fundamental optical mode (e.g., TE0) of the optical signal. That is, the total width W of the 2-mode combiner 200 is such that the higher order optical mode is not “lost” or dissipated prior to reaching the output 212 of the 2-mode combiner 200. When used herein in the context of an optical signal, “TE” denotes “Transverse Electric”.

As shown in FIG. 2D, as one example, when an optical signal having a fundamental optical mode TE0 is launched into the first input waveguide 220 of the 2-mode combiner 200, a higher order optical mode (e.g., TE1) excited by the optical signal transmitted through the 2-mode combiner 200 can be supported by the output waveguide 240. As shown at the output 212, the optical signal transmitted through the 2-mode combiner 200 includes optical modes TE0 and TE1. The optical signal can include 50% TE0 and 50% TE1 at the output 212, for example; other ratios are possible. As shown in FIG. 2E, as another example, when an optical signal having a fundamental optical mode TE0 is launched into the second input waveguide 230 of the 2-mode combiner 200, a higher order optical mode (e.g., TE1) excited by the optical signal transmitted through the 2-mode combiner 200 can be supported by the output waveguide 240. As shown at the output 212 in FIG. 2E, the optical signal transmitted through the 2-mode combiner 200 includes optical modes TE0 and TE1. The optical signal can include 50% TE0 and 50% TE1 at the output 212, for example; other ratios are possible. Regardless of the ratio of optical modes of the optical signal at the output 212, the optical power of the optical signal at the output 212 is substantially the same as the optical power of the optical signal at the input 210.

In at least some embodiments, the output waveguide 240 supports a number of optical modes (e.g., TE0 and TE1) that is equal to or greater than the number of supermodes of the optical signal launched into the input 210 of the 2-mode combiner 200, or rather, into the first input waveguide 220 or the second input waveguide 230.

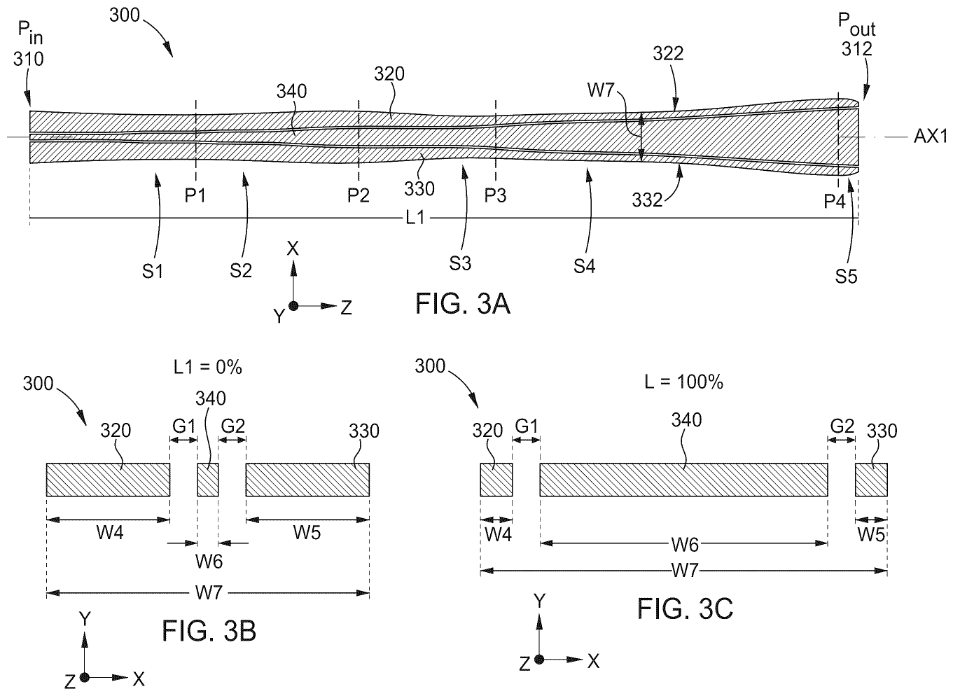

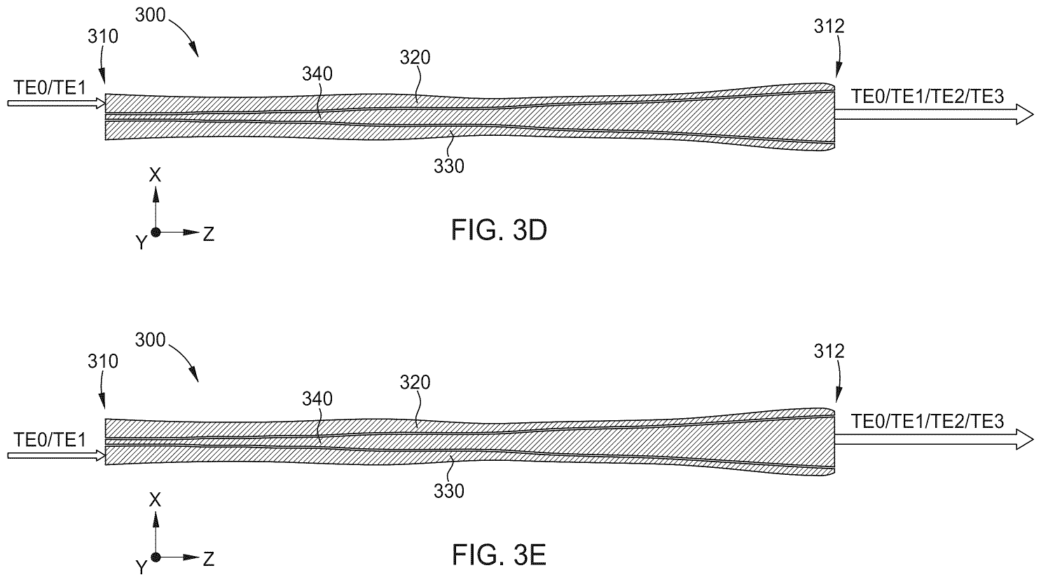

FIGS. 3A, 3B, and 3C depict various views of a 4-mode combiner 300 according to one example embodiment of the present disclosure. FIG. 3A shows a top view of the 4-mode combiner 300 while FIGS. 3B and 3C show cross-sectional views at an input 310 and an output 312 of the 4-mode combiner 300, respectively. The 4-mode combiner 300 can be implemented in the apparatus 100 of FIG. 1, for example. For instance, any one of the 4-mode combiners 145, 165 of the apparatus 100 of FIG. 1 can be configured in a same or similar manner as the 4-mode combiner 300. In addition, for reference, the 4-mode combiner 300 defines a first direction Z, a second direction X, and a third direction Y. The first, second, and third directions Z, X, Y are mutually perpendicular to one another. The 4-mode combiner 300 has a length L1, which extends between the input 310 and the output 312 of the 4-mode combiner 300, e.g., along the first direction Z. In at least some embodiments, the length L1 is equal to or greater than 50 μm.

The 4-mode combiner 300 includes a first input waveguide 320, a second input waveguide 330, and an output waveguide 340 disposed between the first and second input waveguides 320, 330. The waveguides 320, 330, 340 can be formed of silicon, for example. The output waveguide 340 is a multimode waveguide and the first and second input waveguides 320, 330 are also multimode waveguides. The first input waveguide 320 can be associated with a first optical channel and a second optical channel, the second input waveguide 330 can be associated with a third optical channel and a fourth optical channel, and the output waveguide 340 can be associated with the first, second, third, and fourth optical channels. Generally, the 4-mode combiner 300 is arranged so that an optical signal traveling along the first optical channel or the second optical channel can be directed from the first input waveguide 320 to the output waveguide 340, and similarly, so that an optical signal traveling along the third optical channel or the fourth optical channel can be directed from the second input waveguide 330 to the output waveguide 340. In this way, the 4-mode combiner 300 is a 2×1 multimode combiner (two inputs to one output combiner). The 4-mode combiner 300 is generally configured as a Y-combiner. In at least some embodiments, the 4-mode combiner 300 is symmetric along a center axis AX1 extending along the first direction Z. In this regard, the first and second input waveguides 320, 330 mirror each other with respect to the central axis AX1.

The first input waveguide 320 has a width W4, the second input waveguide 330 has a width W5, and the output waveguide 340 has a width W6. The first and second input waveguides 320, 330 and the output waveguide 340 vary in width along the length L1 of the 4-mode combiner 300, with the widths W4, W5 of the first and second input waveguides 320, 330 and the width W6 of the output waveguide 340 varying along the second direction X. In at least some embodiments, the width W6 of the output waveguide 340 inverse tapers along the length L1 from the input 310 to the output 312 of the 4-mode combiner 300. That is, the width W6 of the output waveguide 340 increases as the output waveguide 340 extends toward the output 312 along the first direction Z. Further, in at least some embodiments, the widths W4, W5 of the first and second input waveguides 320, 330 taper, each with a non-linear profile, along the length L1 of the 4-mode combiner 300 from the input 310 to the output 312. In yet other embodiments, the widths W4, W5 of the first and second input waveguides 320, 330 can taper in a linear manner along the length L1 of the 4-mode combiner 300 from the input 310 to the output 312.

In at least some further embodiments, the widths W4, W5 of the first and second input waveguides 320, 330 at the input 310 are each greater than the width W6 of the output waveguide 340 at the input 310. At the output 312 of the 4-mode combiner 300, the width W6 of the output waveguide 340 is greater than the width W4 of the first input waveguide 320 and the width W5 of the second input waveguide 330. In at least some embodiments, the width W6 of the output waveguide 340 at the output 312 of the 4-mode combiner 300 is greater than the width W4 of the first input waveguide 320 and greater than the width W5 of the second input waveguide 330 at the input 310 of the 4-mode combiner 300. This may be appreciated by comparing the widths W4, W5 of the first and second input waveguides 320, 330 in FIG. 3B with the width W6 of output waveguide 340 in FIG. 3C. In at least some embodiments, the output waveguide 340 constantly increases in width along the length L1 of the 4-mode combiner 300 from the input 310 to the output 312. That is, in some embodiments, the width W6 constantly increases along the length L1 from the input 310 to the output 312.

The first input waveguide 320 is spaced from the output waveguide 340 along the second direction X and the second input waveguide 330 is likewise spaced from the output waveguide 340 along the second direction X. Particularly, a first gap G1 is defined between the first input waveguide 320 and the output waveguide 340. Similarly, a second gap G2 is defined between the second input waveguide 330 and the output waveguide 340. In at least some embodiments, the first gap G1 and the second gap G2 remain fixed along the length L1 of the 4-mode combiner 300. Stated differently, the edge-to-edge gap between the first input waveguide 320 and the output waveguide 340 and the edge-to-edge gap between the second input waveguide 330 and the output waveguide 340 can both remain constant along the length L1 of the 4-mode combiner 300.

The 4-mode combiner 300 has a total width W7, as measured from an outer edge 322 of the first input waveguide 320 to an outer edge 332 of the second input waveguide 330. In at least some embodiments, the total width W7 can vary along the length L1 of the 4-mode combiner 300. For the depicted embodiment of FIG. 3A, for example, the total width W7 decreases or remains constant along a first section S1 of the length L1 of the 4-mode combiner 300 from the input 310 until reaching a first inflection plane P1, increases or remains constant along a second section S2 of the length L1 adjacent the first section S1 until reaching a second inflection plane P2, decreases or remains constant along a third section S3 of the length L1 adjacent the second section S2 until reaching a third inflection plane P3, increases or remains constant along a fourth section S4 of the length L1 adjacent the third section S3 until reaching a fourth inflection plane P4, and then decreases or remains constant along a fifth section S5 of the length L1 adjacent the fourth section S4 until reaching the output 312.

In at least some embodiments, the first input waveguide 320, the second input waveguide 330, and the output waveguide 340 are arranged such that an optical signal traveling through the 4-mode combiner 300 has substantially the same optical power at an output of the output waveguide 340 as the optical signal does at an input of either of the first and second input waveguides 320, 330. In this regard, an optical signal traveling through the 4-mode combiner 300 has none or negligible insertion loss. That is, the optical power of an optical signal at the input 310, or Pin, is equal to or approximately equal to the optical power of the optical signal at the output 312, or rather, so that Pin≈Pout. Such a result can be achieved passively by the architecture of the waveguides of the 4-mode combiner 300. For instance, the waveguides 320, 330, 340 of the 4-mode combiner 300 can be arranged such that higher order optical modes excited by transmission of an optical signal through the 4-mode combiner 300 does not radiate away from the waveguides or become “lost” prior to reaching the output 312 of the 4-mode combiner 300. Accordingly, the excited higher order optical modes reach the output 212 of the 4-mode combiner 300 along with the fundamental optical mode and other higher order optical modes present at the input 310. This prevents or greatly reduces the insertion loss of an optical signal transmitted through the 4-mode combiner 300.

In at least some embodiments, for instance, the 4-mode combiner 300 is arranged so that the first input waveguide 320 is wide enough at its input to support two optical modes, the second input waveguide 330 is wide enough at its input to support two optical modes, and the output waveguide 240 is wide enough at its output to support at least four optical modes. Stated another way, in some embodiments, the total width W7 of the 4-mode combiner 300 is wide enough along its length L so that higher order optical modes (e.g., TE2, TE3) excited by the optical signal traveling through the 4-mode combiner 300 is supported by the 4-mode combiner 300, in addition to the fundamental optical mode (e.g., TE0) and a higher order optical mode present at the input 310 (e.g., TE1). That is, the total width W7 of the 4-mode combiner 300 is such that the excited higher order optical modes are not “lost” or dissipated prior to reaching the output 312 of the 4-mode combiner 300.

As shown in FIG. 3D, as one example, when an optical signal having a fundamental optical mode TE0 and higher order optical signal TE1 is launched into the first input waveguide 320 of the 4-mode combiner 300, a higher order optical mode (e.g., TE2) is excited by optical mode TE0 and a higher order optical mode (e.g., TE3) is excited by optical mode TE1. The optical modes TE0, TE1, TE2, and TE3 can be supported by the output waveguide 340. As shown at the output 312, the optical signal transmitted through the 4-mode combiner 300 includes optical modes TE0, TE1, TE2, TE3. The optical signal can include 25% TE0, 25% TE1, 25% TE2, and 25% TE3 at the output 312, for example; other ratios are possible. As shown in FIG. 3E, as another example, when an optical signal having a fundamental optical mode TE0 and higher order optical signal TE1 is launched into the second input waveguide 330 of the 4-mode combiner 300, a higher order optical mode (e.g., TE2) is excited by optical mode TE0 and a higher order optical mode (e.g., TE3) is excited by optical mode TE1. The optical modes TE0, TE1, TE2, and TE3 can be supported by the output waveguide 340. As shown at the output 312, the optical signal transmitted through the 4-mode combiner 300 includes optical modes TE0, TE1, TE2, TE3. The optical signal can include 25% TE0, 25% TE1, 25% TE2, and 25% TE3 at the output 312, for example; other ratios are possible. Regardless of the ratio of optical modes of the optical signal at the output 312, the optical power of the optical signal at the output 312 is substantially the same as the optical power of the optical signal at the input 310.

In at least some embodiments, the output waveguide 340 supports a number of optical modes (e.g., TE0, TE1, TE2, TE3) that is equal to or greater than the number of supermodes of the optical signal launched into the input 310 of the 4-mode combiner 300, or rather, into the first input waveguide 320 or the second input waveguide 330.

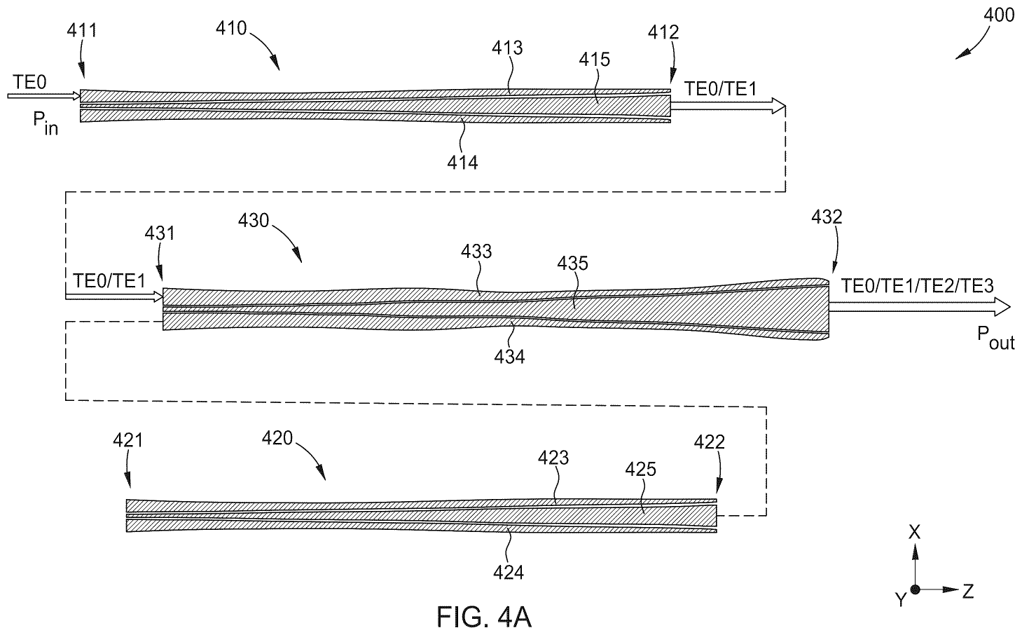

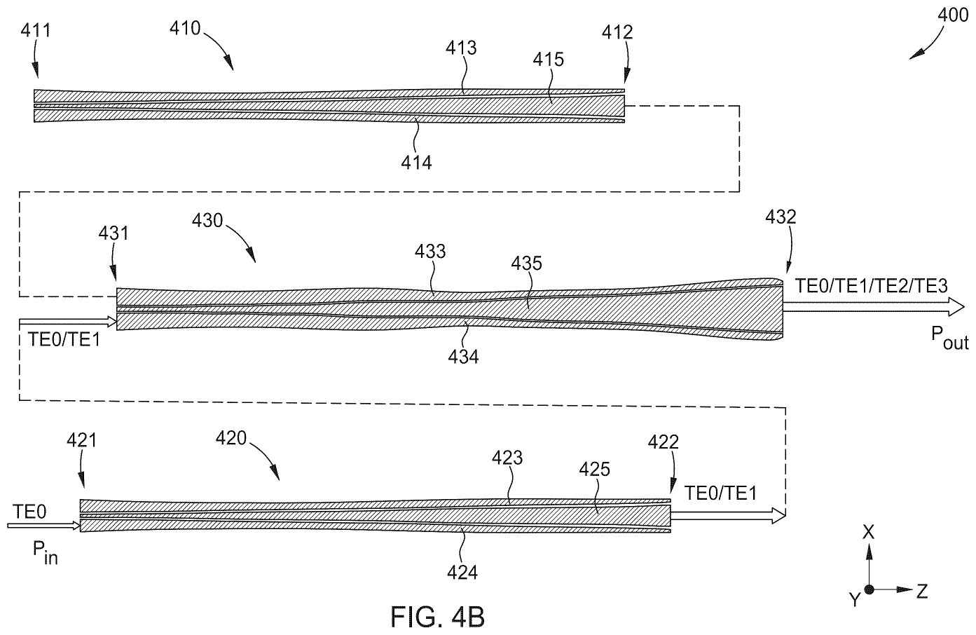

FIGS. 4A and 4B depict top views of a multiplexer 400 according to one example embodiment of the present disclosure. The multiplexer 400 can be implemented in the apparatus 100 of FIG. 1, for example. For instance, the first multiplexer 140 and/or the second multiplexer 160 of the apparatus 100 of FIG. 1 can be configured in a same or similar manner as the multiplexer 400. For reference, the multiplexer 400 defines a first direction Z, a second direction X, and a third direction Y. The first, second, and third directions Z, X, Y are mutually perpendicular to one another.

As depicted in FIGS. 4A and 4B, the multiplexer 400 includes a first combiner 410 having an input 411 and an output 412. The first combiner 410 has two single mode input waveguides 413, 414 and one multimode output waveguide 415 disposed between the two single mode input waveguides 413, 414. The multiplexer 400 also includes a second combiner 420 having an input 421 and an output 422. The second combiner 420 has two single mode input waveguides 423, 424 and one multimode output waveguide 425 disposed between the two single mode input waveguides 423, 424. The first and second combiners 410, 420 can be configured in a same or similar manner as the 2-mode combiner 200 of FIG. 2A. The multiplexer 400 further includes a third combiner 430 having an input 431 and an output 432. The third combiner 430 has two multimode input waveguides 433, 434 and one multimode output waveguide 435. The two multimode input waveguides 433, 434 of the third combiner 430 are respectively coupled with the multimode output waveguides 415, 425 of the first and second combiners 410, 420. The third combiner 430 can be configured in a same or similar manner as the 4-mode combiner 300 of FIG. 3A. The first and second combiners 410, 420 are arranged in a cascade arrangement with the third combiner 430. The third combiner 430 can have a length that is at least twice as great as a length of the first combiner 410 and at least twice as great as a length of the second combiner 420.

The first combiner 410, the second combiner 420, and the third combiner 430 are arranged such that an optical signal transmitted through the multiplexer 400 has substantially the same optical power at the output 432 of the multimode output waveguide 435 of the third combiner 430 as the optical signal does at the input (e.g., the input 411 or the input 421) of any one of the single mode input waveguides 413, 414, 423, 424 of the first combiner 410 or the second combiner 420. In this regard, an optical signal transmitted through the multiplexer 400 has none or negligible insertion loss. That is, the optical power of an optical signal at one of the inputs 411, 421, or Pin, is equal to or approximately equal to the optical power of the optical signal at the output 432, or Pout, or stated mathematically, so that Pin≈Pout. Such a result can be achieved passively by the architecture of the waveguides of the combiners 410, 420, 430.

For instance, the waveguides 413, 414, 415 of the first combiner 410 can be arranged such that a higher order optical mode excited by transmission of an optical signal through the first combiner 410 does not radiate away from the waveguides or become “lost” prior to reaching the output 412. Accordingly, a higher order optical mode can reach the output 412 along with the fundamental optical mode of an optical signal. Similarly, the waveguides 423, 424, 425 of the second combiner 420 can be arranged such that a higher order optical mode excited by transmission of an optical signal through the second combiner 420 does not radiate away from the waveguides or become “lost” prior to reaching the output 422. Thus, a higher order optical mode can reach the output 422 along with the fundamental optical mode of an optical signal. The architectural arrangements of the first and second combiners 410, 420 can thus prevent or greatly reduces the insertion loss of an optical signal transmitted therethrough.

In at least some embodiments, the first combiner 410 and the second combiner 420 can each be arranged so that their single mode input waveguides are each wide enough at their inputs to support one optical mode and so that their multimode output waveguides are each wide enough to support two optical modes. Stated another way, in some embodiments, the total width of the first combiner 410 and the second combiner 420 can each be wide enough along their respective lengths so that a higher order optical mode (e.g., TE1) excited by an optical signal traveling therethrough is supported, in addition to the fundamental optical mode (e.g., TE0) of the optical signal.

Further, the waveguides 433, 434, 435 of the third combiner 430 can be arranged such that higher order optical modes excited by transmission of an optical signal through the third combiner 430 does not radiate away from the waveguides or become “lost” prior to reaching the output 432. Accordingly, higher order optical modes can reach the output 432 along with the fundamental optical mode of an optical signal. Accordingly, the excited higher order optical modes can reach the output 432 along with the fundamental optical mode and other higher order optical modes present at the input 431. This can prevent or greatly reduces the insertion loss of an optical signal transmitted through the third combiner 430.

In at least some embodiments, the third combiner 430 is arranged so that the multimode input waveguides 433, 434 are each wide enough at the input 431 to support two optical modes and so that the multimode output waveguide 435 is wide enough at its output to support at least four optical modes. Stated another way, in some embodiments, the total width of the third combiner 430 is wide enough along its length L so that higher order optical modes (e.g., TE2, TE3) excited by the optical signal traveling through the third combiner 430 are supported, in addition to the fundamental optical mode (e.g., TE0) and any higher order optical modes present at the input 431 (e.g., TE1).

FIG. 4A shows an optical signal being transmitted through the multiplexer 400 along one optical channel. As depicted in FIG. 4A, when an optical signal having a fundamental optical mode TE0 is transmitted through the input waveguide 413 (or alternatively the input waveguide 414) of the first combiner 410, a higher order optical mode (e.g., TE1) excited by the optical signal transmitted through the first combiner 410 can be supported by the multimode output waveguide 415. At the output 412 of the first combiner 410, or more particularly at the output of the multimode output waveguide 415, the optical signal transmitted through the first combiner 410 includes optical modes TE0 and TE1. The optical signal can include 50% TE0 and 50% TE1 at the output 412, for example; other ratios are possible. Accordingly, the higher order optical mode (e.g., TE1) is not “cutoff” by the architecture of the first combiner 410. In at least some embodiments, the output waveguide 415 supports a number of optical modes (e.g., TE0, TE1) that is equal to or greater than the number of supermodes of the optical signal launched into the input 411 of the first combiner 410.

After transmission through the first combiner 410, the optical signal travels to the third combiner 430, e.g., along a signal path wide enough to accommodate the number of optical modes of the optical signal at the output 412 of the first combiner 410. When the optical signal having the fundamental optical mode TE0 and higher order optical signal TE1 is transmitted through the multimode input waveguide 433 of the third combiner 430, a higher order optical mode (e.g., TE2) is excited by optical mode TE0 and a higher order optical mode (e.g., TE3) is excited by optical mode TE1. The optical modes TE0, TE1, TE2, and TE3 can be supported by the multimode output waveguide 435. At the output 432, the optical signal transmitted through the third combiner 430 includes optical modes TE0, TE1, TE2, and TE3. The optical signal can include 25% TE0, 25% TE1, 25% TE2, and 25% TE3 at the output 432, for example; however, other ratios are possible. Accordingly, the higher order optical modes (e.g., TE2, TE3) are not “cutoff” by the architecture of the third combiner 430. Regardless of the ratio of optical modes of the optical signal at the output 432, the optical power of the optical signal at the output 432 of the third combiner 430 is substantially the same as the optical power of the optical signal at the input 411 of the first combiner 410. In at least some embodiments, the output waveguide 435 supports a number of optical modes (e.g., TE0, TE1, TE2, TE3) that is equal to or greater than the number of supermodes of the optical signal launched into the input 431 of the third combiner 430.

In some embodiments, after transmission through the third combiner 430, the optical signal having optical modes TE0, TE1, TE2, TE3 can travel to a photodetector, for example. In other embodiments, after transmission through the third combiner 430, the optical signal having optical modes TE0, TE1, TE2, TE3 can travel to a fourth combiner arranged in a cascade arrangement with the third combiner and a combiner of a second multiplexer configured in a same manner as the multiplexer 400. The fourth combiner can include a pair of multimode input waveguides and a multimode output waveguide disposed between the multimode input waveguides. One of the multimode input waveguides of the fourth combiner can be in optical communication with the multimode output waveguide 434 of the third combiner 430 and the other multimode input waveguide can be in optical communication with the combiner of the second multiplexer. The fourth combiner, or the multimode output waveguide thereof, can be arranged to support at least eight optical modes.

FIG. 4B shows an optical signal being transmitted through the multiplexer 400 along another optical channel. As depicted in FIG. 4B, when an optical signal having a fundamental optical mode TE0 is transmitted through the input waveguide 424 (or alternatively the input waveguide 423) of the second combiner 420, a higher order optical mode (e.g., TE1) excited by the optical signal transmitted through the second combiner 420 can be supported by the multimode output waveguide 425. At the output 422 of the second combiner 420, or more particularly at the output of the multimode output waveguide 425, the optical signal transmitted through the second combiner 420 includes optical modes TE0 and TE1. The optical signal can include 50% TE0 and 50% TE1 at the output 422, for example; other ratios are possible. Accordingly, the higher order optical mode (e.g., TE1) is not “cutoff” by the architecture of the second combiner 420. In at least some embodiments, the output waveguide 425 supports a number of optical modes (e.g., TE0, TE1) that is equal to or greater than the number of supermodes of the optical signal launched into the input 421 of the second combiner 420.

After transmission through the second combiner 420, the optical signal travels to the third combiner 430, e.g., along a signal path wide enough to accommodate the number of optical modes of the optical signal at the output 422 of the second combiner 420. When the optical signal having the fundamental optical mode TE0 and higher order optical signal TE1 is transmitted through the multimode input waveguide 434 of the third combiner 430, a higher order optical mode (e.g., TE2) is excited by optical mode TE0 and a higher order optical mode (e.g., TE3) is excited by optical mode TE1. The optical modes TE0, TE1, TE2, and TE3 can be supported by the multimode output waveguide 435. As shown at the output 432, the optical signal transmitted through the third combiner 430 includes optical modes TE0, TE1, TE2, and TE3. The optical signal can include 25% TE0, 25% TE1, 25% TE2, and 25% TE3 at the output 432, for example; however, other ratios are possible. Accordingly, the higher order optical modes (e.g., TE2, TE3) are not “cutoff” by the architecture of the third combiner 430. Regardless of the ratio of optical modes of the optical signal at the output 432, the optical power of the optical signal at the output 432 of the third combiner 430 is substantially the same as the optical power of the optical signal at the input 421 of the second combiner 420. In at least some embodiments, the output waveguide 435 supports a number of optical modes (e.g., TE0, TE1, TE2, TE3) that is equal to or greater than the number of supermodes of the optical signal launched into the input 431 of the third combiner 430.

As noted above, in some embodiments, after transmission through the third combiner 430, an optical signal having optical modes TE0, TE1, TE2, TE3 can travel to a photodetector, another combiner, some other photonic component, etc.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s).

In view of the foregoing, the scope of the present disclosure is determined by the claims that follow.

We claim:

1. A multimode combiner, comprising:
a first input waveguide;
a second input waveguide; and
an output waveguide disposed between the first and second input waveguides,
wherein the first input waveguide, the second input waveguide, and the output waveguide are arranged such that an optical signal transmitted through the multimode combiner has substantially the same optical power at an output of the output waveguide as the optical signal does at an input of either of the first and second input waveguides.

2. The multimode combiner of claim 1, wherein the output waveguide is a multimode waveguide and the first and second input waveguides are single mode waveguides.

3. The multimode combiner of claim 1, wherein the output waveguide supports at least a number of optical modes as supermodes of the optical signal launched into an input of the multimode combiner.

4. The multimode combiner of claim 1, wherein the multimode combiner has a length extending along a first direction, and wherein the first and second input waveguides and the output waveguide have widths that vary along the length of the multimode combiner, with the widths of the first and second input waveguides and the width of the output waveguide varying along a second direction perpendicular to the first direction.

5. The multimode combiner of claim 4, wherein the width of the output waveguide inverse tapers along the length from an input to an output of the multimode combiner.

6. The multimode combiner of claim 4, wherein the widths of the first and second input waveguides taper, each with a non-linear profile, along the length from an input to an output of the multimode combiner.

7. The multimode combiner of claim 1, wherein the multimode combiner is symmetric along a center axis extending along a first direction.

8. The multimode combiner of claim 1, wherein, at an input of the multimode combiner, the first and second input waveguides each have widths that are greater than a width of the output waveguide.

9. The multimode combiner of claim 1, wherein, at an output of the multimode combiner, a width of the output waveguide is greater than a width of the first input waveguide and a width of the second input waveguide.

10. The multimode combiner of claim 1, wherein a width of the output waveguide at an output of the multimode combiner is greater than a width of the first input waveguide and a width of the second input waveguide at an input of the multimode combiner.

11. The multimode combiner of claim 1, wherein the output waveguide constantly increases in width along a length of the multimode combiner.

12. The multimode combiner of claim 1, wherein a first gap between the first input waveguide and the output waveguide remains fixed along a length of the multimode combiner and a second gap between the second input waveguide and the output waveguide remains fixed along the length.

13. The multimode combiner of claim 1, wherein a total width, as measured from an outer edge of the first input waveguide to an outer edge of the second input waveguide, decreases or remains constant along a first section of a length of the multimode combiner from an input of the multimode combiner to a first inflection plane, increases or remains constant along a second section of the length adjacent the first section until reaching a second inflection plane, and then decreases or remains constant along a third section of the length adjacent the second section until reaching an output of the multimode combiner.

14. The multimode combiner of claim 1, wherein a total width, as measured from an outer edge of the first input waveguide to an outer edge of the second input waveguide, is wide enough so that a higher order optical mode excited by the optical signal transmitted through the multimode combiner is supported by the multimode combiner, in addition to a fundamental optical mode of the optical signal.

15. A multiplexer, comprising:
a first combiner having two single mode input waveguides and one multimode output waveguide;
a second combiner having two single mode input waveguides and one multimode output waveguide; and
a third combiner having two multimode input waveguides and one multimode output waveguide, the two multimode input waveguides of the third combiner are respectively coupled with the multimode output waveguides of the first and second combiners, and
wherein the multimode output waveguides of the first, second, and third combiners each support, at their respective outputs, at least one higher order optical mode in addition to a fundamental mode of an optical signal transmitted therethrough, with the multimode output waveguide of the third combiner supporting at least twice a number of optical modes that the multimode output waveguides of the first and second combiners support.

16. The multiplexer of claim 15, wherein the first, second, and third combiners each have a center axis, and wherein the first, second, and third combiners are symmetric along their respective center axes.

17. The multiplexer of claim 15, wherein a width of the multimode output waveguide of the third combiner is at least twice as great as a width of the multimode output waveguide of the first combiner and at least twice as great as a width of the multimode output waveguide of the second combiner.

18. An apparatus, comprising:
a photodetector having an input; and
a multiplexer, comprising:
a first stage having a first combiner and a second combiner each having two single mode input waveguides and one multimode output waveguide; and
a second stage having a third combiner having two multimode input waveguides and one multimode output waveguide, the two multimode input waveguides of the third combiner are respectively coupled with the multimode output waveguides of the first and second combiners, the multimode output waveguide of the third combiner is coupled with the input of the photodetector, and
wherein the first combiner, the second combiner, and the third combiner are arranged such that an optical signal launched into an input of any one of the single mode input waveguides of the first combiner or the second combiner and transmitted through the third combiner has substantially the same optical power at the input of the photodetector as the optical signal does at the input of any one of the single mode input waveguides of the first combiner or the second combiner.

19. The apparatus of claim 18, wherein the photodetector has a second input, and wherein the apparatus further comprises:
a second multiplexer, comprising:
a first stage having a fourth combiner and a fifth combiner each having two single mode input waveguides and one multimode output waveguide; and
a second stage having a sixth combiner having two multimode input waveguides and one multimode output waveguide, the two multimode input waveguides of the sixth combiner are respectively coupled with the multimode output waveguides of the fourth and fifth combiners, the multimode output waveguide of the sixth combiner is coupled with the second input of the photodetector, and
wherein the fourth combiner, the fifth combiner, and the sixth combiner are arranged such that an optical signal launched into an input of any one of the single mode input waveguides of the fourth combiner or the fifth combiner and transmitted through the sixth combiner has substantially the same optical power at the second input of the photodetector as the optical signal does at the input of any one of the single mode input waveguides of the fourth combiner or the fifth combiner.

20. The apparatus of claim 18, wherein a width of the multimode output waveguide of the first combiner, at an output of the first combiner, matches a width of each one of the multimode input waveguides of the third combiner, at an input of the third combiner.
